(19) United States
(12) Patent Application Publication
(10) Pub. No.: US 2012/0164606 A1
(43) Pub. Date: Jun. 28, 2012

(54) APPARATUS AND METHOD FOR PROVIDING STORY MAKING SERVICE

(75) Inventors: Hwa-Shin MOON, Daejeon (KR); Kang-Yong LEE, Daejeon (KR); Jae-Cheol SIM, Daejeon (KR); Kee-Seong CHO, Daejeon (KR); Won RYU, Daejeon (KR)

(73) Assignee: Electronics and Telecommunications Research Institute, Daejeon (KR)

(21) Appl. No.: 13/334,540

(22) Filed: Dec. 22, 2011

(30) Foreign Application Priority Data
Dec. 23, 2010 (KR) 10-2010-0133989

(51) Int. Cl. G09B 19/00

(52) U.S. Cl. 434/156

(57) ABSTRACT

Disclosed is a method for providing a story making service enabling multiple users to modify/change/rewrite contents, the method for providing a story making service includes: recommending and selecting the contents so as to help the users to select the contents performing the story making; determining a group to create or select the group using the story making together for the selected contents; generating and transmitting information necessary to provide services within the selected group; and reconfiguring a story to perform modification/change/rewriting works on the story within the selected contents and the selected service group.

### CROSS-REFERENCE TO RELATED APPLICATIONS

The present application claims priority of Korean Patent Application No. 10-2010-0133989, field on Dec. 23, 2010, which is incorporated herein by reference in its entirety.

### BACKGROUND OF THE INVENTION

1. Field of the Invention

Exemplary embodiments of the present invention relate to an apparatus and a method for providing content using services, and more particularly, to an apparatus and a method for configuring social networking based on a profile and a content using history of a user and providing a story making service based on the configured social networking.

2. Description of Related Art

As various networks, led by the development of Internet are developed, transmittable capacity of data has been increased. In addition, the user's desire to enjoy more various services has also been increased. As a result, multimedia contents rather than contents using a single media become more popular. The contents are purchased and consumed by a user in one form or another.

Although numerous types of contents are currently developed through various online media, there are many contents providing characteristics as such user participation and interaction between users in contents surviving in a consumption structure in which the contents are purchased and consumed by the users. For instance, e-mail and Internet café that are popular in Internet industries in Korea have largely two common points. First, one is that individuals may directly use the e-mail and the Internet café and the other is that individuals interact with one another so as to transmit and share information.

A success of the contents providing the interaction may also be reviewed through Internet online games, individual mini home page, twitter, or the like. That is, the existing public media unilaterally providing information are being changed to new media enabling the interaction of information sharing by the user. Further, many attempts have been conducted even in the existing medium so as to develop the contents that enable the interaction of information sharing.

A representative example of the interaction that has been developed in the existing medium may include, for example, FM radio broadcasting. The existing FM radio broadcasting has been conducted while being limited to broadcasting that provides music or reads a letter transferred from the user. However, a type of broadcasting inducing the listener participation that is on the phone with a viewer in real time, communication with a viewer using a real-time bulletin board and services referred to as a type of visual radio out of a format of radio are provided.

Further, contents such as novels and movies have an established unfolding and conclusion of a story in advance by an original author' intention and therefore, the intervention of a reader is originally blocked. However, various attempts to provide interaction to works such as novels and movies have been recently conducted. There has been proposed a concept of configuring the novels as printed matters having a plurality of card types and changing the contents of novels by readers so as to configure various stories. In addition, even in the image works such as movies, there has been proposed a method for unfolding and converting a story of image works that previously produce the story of image works in various forms according to characters, conflict factors, reversal factors, or the like, and then, unfold the story according to the user's selection.

However, the method for providing the interaction proposed in contents such as novels and movies has a simple participation type of selecting and arranging several stories previously produced by a producer. Therefore, a need exists for a method for enabling more participations and interactions so as for more consumers to consume the contents such as novels or movies in consideration of the change in the existing content consumption type.

### SUMMARY OF THE INVENTION

An embodiment of the present invention is directed to an apparatus and a method for providing a story making service capable of modifying contents by users having a similar taste.

Another embodiment of the present invention is directed to provide an apparatus and a method for providing a story making service capable of creating new consumers.

Still another embodiment of the present invention is directed to provide an apparatus and a method for providing a story making service capable of providing participation and interaction to a user.

In accordance with an embodiment of the present invention, a method for providing a story making service enabling multiple users to modify/change/rewrite contents includes: recommending and selecting the contents so as to help the users to select the contents performing the story making; determining a group to create or select the group using the story making together for the selected contents; generating and transmitting information necessary to provide services within the selected group; and reconfiguring a story to perform modification/change/rewriting works on the story within the selected contents and the selected service group.

In accordance with another embodiment of the present invention, an apparatus for providing a story making service enabling multiple users to modify/change/rewrite contents includes: a user profile managing unit configured to manage taste information of the user; a social network managing unit configured to write and manage social network information for each individual based on history information regarding the story making service used by the user; and a group based content reconfiguration managing unit configured to recommend a group using the story making service to the individual based on the individual taste information and the social network information for each individual and provide a content reconfiguration service to the group selected by the individual.

### BRIEF DESCRIPTION OF THE DRAWINGS

FIG. 1A is a diagram illustrating an example of providing, in a menu form, a story making service for contents purchased and consumed by an individual.

FIG. 1B is a configuration diagram of an interface provided to enable a user to access the story making service for each content previously purchased by the user.

FIG. 1C is a configuration diagram of an example of an interface when being provided as a story making service dimension.

FIG. 1D is a configuration diagram of an example of an interface shown when a user accesses the story making service for specific contents through the processes of FIGS. 1A to 1C as described above.

FIG. 1E is a configuration diagram of an example of an interface shown at a terminal of each user so as to perform a story reconfiguration within a selected group.

FIG. 2 is a flow chart illustrating a method for providing a story making service in accordance with an embodiment of the present invention.

FIG. 3 is a flow chart of a process of recommending contents to a user so as to help selection of contents using the story making service by the user in accordance with the embodiment of the present invention.

FIG. 4 is a conceptual diagram for describing a method for generating a service group to be used together with the story making service.

FIG. 5 is a flow chart of a preparation working process for providing the story making stories to a selected or created group.

FIG. 6 is a flow chart of an operation performed when a modification work for actual contents is performed within a group in which the user uses the story making service.

FIG. 7 is an operating flow chart when the user ends services.

FIG. 8 is a configuration diagram illustrating an apparatus for providing a story making service in accordance with the embodiment of the present invention.

FIG. 9 is a configuration diagram of a group based content reconfiguration managing unit in the apparatus for providing a story making service in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention propose a technology of providing new services to enable multiple users to participate the contents as novels and movies and enjoy the contents. In particular, exemplary embodiments of the present invention propose a technology capable of enabling multiple users to interact with one another so as to modify/change/rewrite provided stories and enjoy the stories. Further, exemplary embodiments of the present invention are to inform persons having the same tastes upon changing stories.

Hereinafter, exemplary embodiments of the present invention will be described in detail with reference to the accompanying drawings.

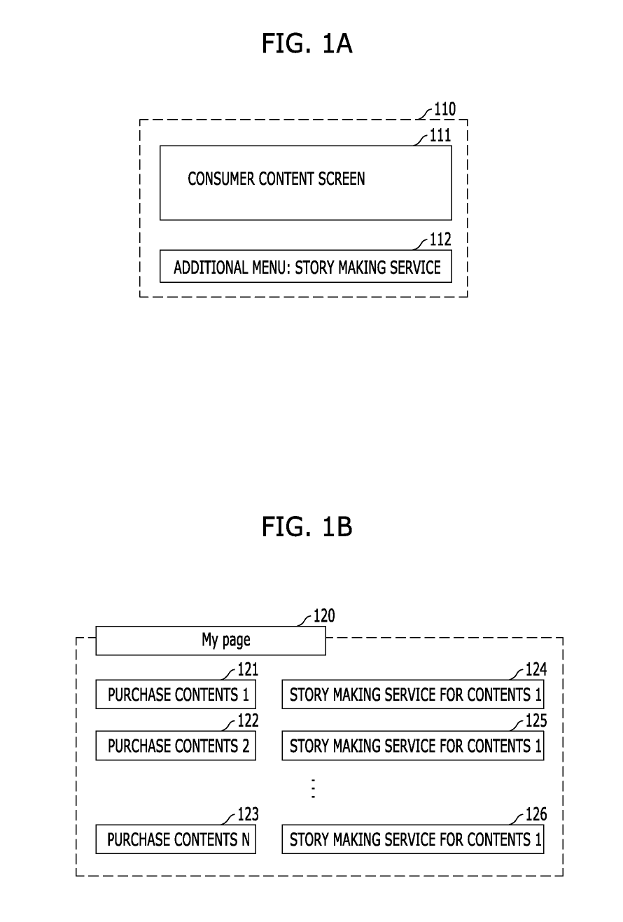

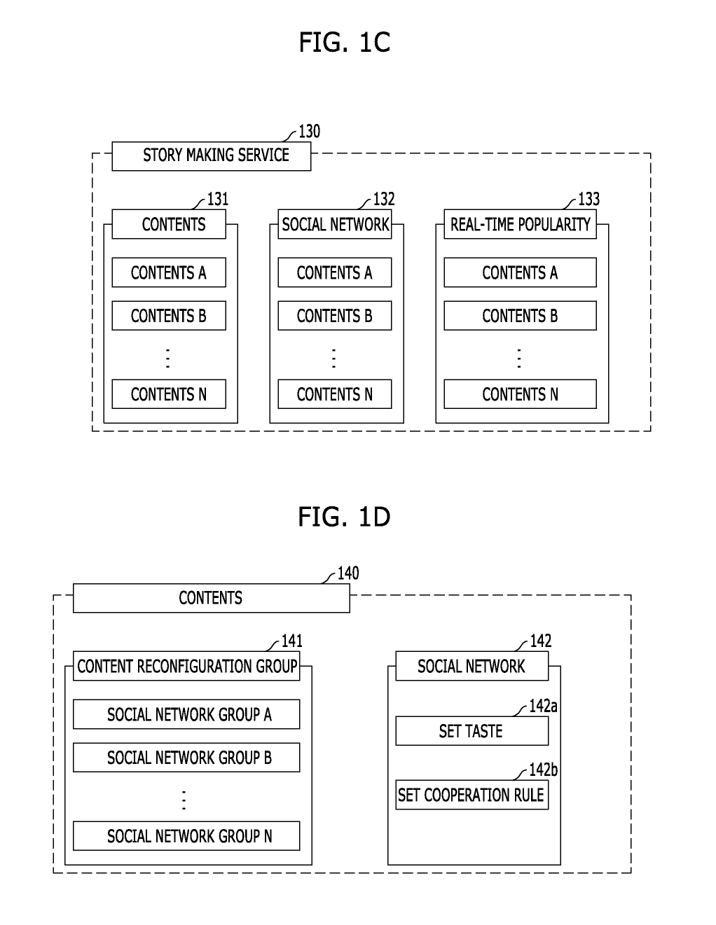

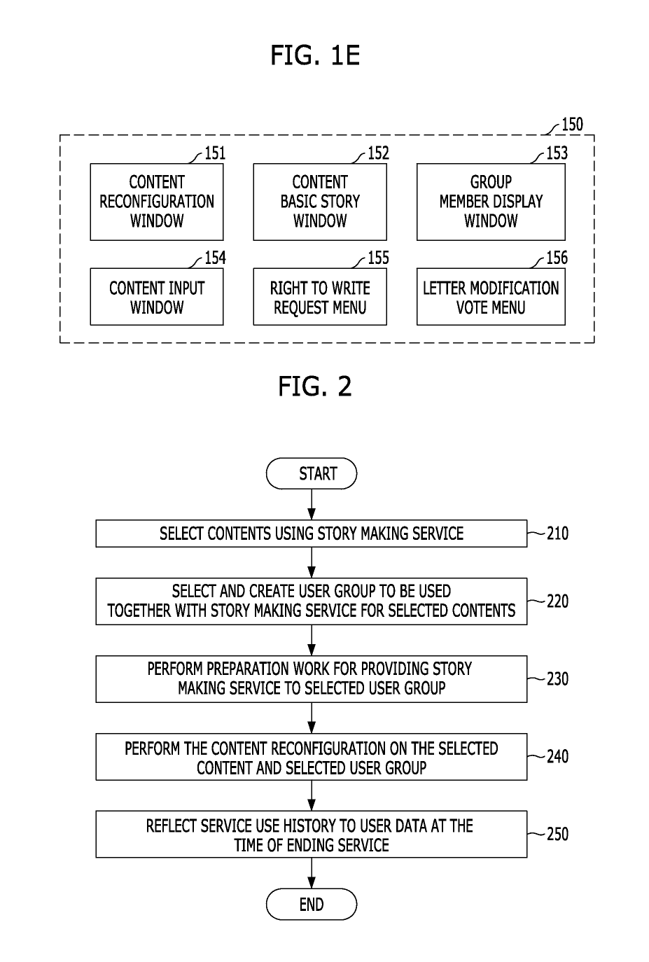

FIGS. 1A to 1E illustrate examples of actually applying a story making service in accordance with an embodiment of the present invention.

The story making service proposed in the embodiments of the present invention means a service that enables multiple users to commonly reconfigure and enjoy the existing stories of the contents of which the stories are general novels and movies. Therefore, additional services for original contents to be reconfigured may be distributed.

FIG. 1A is a diagram illustrating an example of providing, in a menu form, a story making service for contents purchased and consumed by an individual.

FIG. 1A illustrates a menu capable of supporting a story making service as a consumption content screen menu 111 that are being currently consumed in the entire screen 110 for contents and an additional menu 112. The story making service provided in the menu form may be provided to contents that are being currently consumed and contents that are consumed in the past.

FIG. 1B is a configuration diagram of an interface provided to enable a user to access the story making service for each content previously purchased by the user as an example of using the contents that are consumed in the past.

FIG. 1B illustrates my page 120 to display a service history that is consumed in the past, wherein previously purchased contents 121 to 123 are listed in the inside of the my page 120 and menus 124 to 126 capable of supporting the story making service for each purchase contents are configured therein.

In addition, the story making service may also be provided so as to increase the number of users using the media in a content distribution media. A business centrally providing only the story making service for the contents that are being currently used can also be fulfilled. However, since the business creates a great synergy effect when the story making service is combined with the existing distribution media, the case in which the story making service is combined with the existing distribution media will be centrally described.

FIG. 1C illustrates an example of an interface when being provided as a story making service dimension. When being provided as the service dimension, the user may use the services for the desired contents. In this case, for providing convenience of individuals, the service may recommend contents that may be preferred by individuals according to a user's taste. The taste may be divided into several fields such as a taste 131 for individual contents, a taste 132 for a user group (social network based group) currently using the services, or a content rank 133 that is currently popular, or the like, as illustrated in FIG. 1C and may be determined by a combination thereof.

FIG. 1D is a configuration diagram of an example of an interface shown when a user accesses the story making service for specific contents through the processes of FIGS. 1A to 1C as described above.

As illustrated in FIG. 1D, the user accessing the story making service for contents 140 may see each group that performs a story reconfiguration for contents through a content reconfiguration group field 141 and may confirm basic information regarding each group. In addition, the existing groups are ranked so as to meet the user preference and may be seen to the user.

If there is no congenial group among the groups for reconfiguring the contents that are being currently progressed, the user may create a group for directly performing the story making through a group generation field 142. When creating the group, the tastes to be shared in the newly created group may be specified in a taste setting field 142a so as to easily collect persons having the same tastes. As the tastes, a specific portion (for example, N times drama, N chapter novel) of contents, an interest relation (for example, main characters A and B, minor characters C and D), an ending direction (for example, sad ending, happy ending), or the like, may be considered. In addition, a cooperation method of the newly created group may also be previously set through a cooperation rule setting (cooperation rule setting) field 142b. In this case, as the cooperation rule that may be set, there are a content writing sequence (for example, participants sequentially writing the contents, the user holding up his/her own hand to the corresponding portion and allocated with a right to write (hereinafter, expressed as a right to speak) and then, writing the contents), the largest number of people permitted to the group, whether a letter written by each individual is modified (for example, no modification of a letter written by other persons, a request a modification of a specific portion, and perform a modification through a vote, or the like), or the like.

When the user forms a group, the story making service may send an invitation message to another user based on the social network formed from the service use history of the exiting user by the user request. In addition, when the group is created by the user request, the invitation message may be sent to the users having similar natures based on the written tastes and cooperation rules.

FIG. 1E is a configuration diagram of an example of an interface shown at a terminal of each user so as to perform a story reconfiguration within a selected group.

In FIG. 1E, an interface 150 of a user terminal performing the story reconfiguration is configured to include a content reconfiguration window 151, a content basic story window 152, a group member display window 153, a content input window 154, a right to write request menu 155, and a letter modifying vote menu 156.

The terminal in which the story making service is supported combines data provided in a system providing the social networking based story making service to configure the interface 150 similar to the configuration of FIG. 1E. The interface 150 may basically include the content reconfiguration window 151 that enables individuals to see the story reconfigured up to now and the content input window 154 that inputs the stories. In addition, there may be the content basic story window 152 through which the existing story of the contents to be additionally reconfigured is seen. The convenience of user may be improved by enabling some of the existing story to be used in the reconfigured contents in the content basic story window 152.

Further, there may be the group member display window 153 showing a list of the members included in the current group. The user can also confirm the member having the current right to speak in the group member display window 153. Further, there may be the right to speak (right to write) request menu 155 according to the cooperation rule written at the time of creating the group or the letter modifying vote menu 156 proposing the letter modification vote and performing the vote. Further, a chatting function between the created group members may additionally be provided as well.

FIG. 2 is a flow chart illustrating a method for providing a story making service in accordance with an embodiment of the present invention. The story making service to be provided by the embodiment of the present invention includes a content selecting process 210 including recommending the contents corresponding to the user request so as to help a user to select the contents using the story making service, a group determining process 220 of generating or selecting a group using the story making service for the selected contents, a preparation process 230 of providing the story making service within the selected group; and a story reconfiguring process 240 of performing the modification/change/re-writing work on the story within the selected contents and the selected service use group. In addition, in order to additionally provide a personalization service for the convenience of user at acts 210, 220, and 240, the user profile and social networking information is managed and the personalization service may be provided based on the managed information in the system providing the story making service. Further, upon managing the user profile and the social networking information, a process 250 of reflecting the service use history used by the user to the profile and the social networking information that are managed in the system may be performed at the time of ending the services.

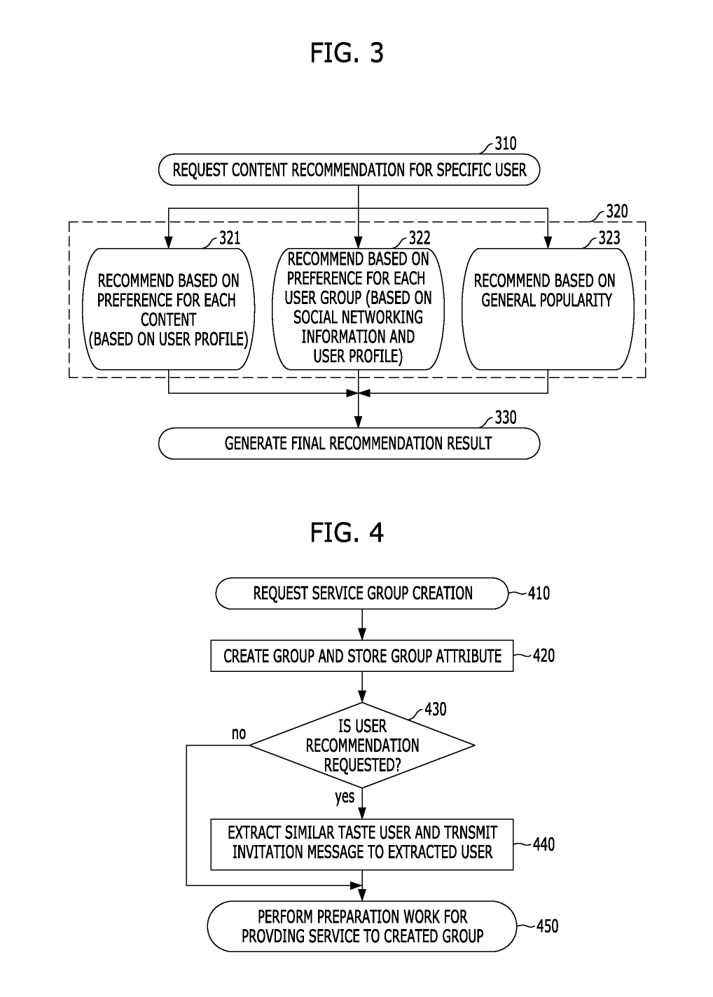

FIG. 3 is a flow chart of a process of selecting the contents using the story making service by the user according to the embodiment of the present invention.

FIG. 3 illustrates a process 210 of FIG. 2, that is, a series of procedures performed in a process of selecting the contents using the story making service by the user. Upon using the story making service, the method for selecting contents using the story making service by the user is performed through one of largely three processes.

The first process corresponds to a case in which the user directly requests the story making service to the contents that are being currently consumed. As described above, FIG. 1A describes an example of the user interface when the method is applied.

The second process corresponds to a case in which the user selects one of the contents that are previously purchased and consumed and requests the direct story making service to the selected contents. This case corresponds to an example of the story making service to which the user interface of FIG. 1B is applied.

The third process corresponds to a case in which the user directly searches the desired contents and requests the searched services. In this case, for the convenience of user, the service needs to recommend the contents that the corresponding user is highly likely to use the services to the user. The case is an example of the story making service to which the interface of FIG. 1C is applied.

At a process 310, if “the recommendation of the contents for the story making service for a specific user” is requested, the content list suitable for the user is calculated based on the user profile, the social network, and the general preference at a process 520 and at a process 330, the final recommendation results integrating the contents recommended at the process 320 are generated.

In this case, the recommendation may be made based on the personal preference for the contents using the user profile as illustrated in FIG. 3, the recommendation may be made based on the preference for the user group in which the current service is performed for each content (based on the social network information), and the recommendation may also be made based on a ranking of the contents that are currently popular, i.e., are the most frequently serviced. In addition, the recommendation may also be made by the combination thereof.

In addition, there is a method for using the story making service for the contents that are the object of invitation by additionally accepting the invitation of another user. Unlike other cases, however, the case has a characteristic of selecting the service user group while accepting the invitation.

When the contents using the story making services are determined by the user, the process proceeds to a process of generating or selecting the user group using the services together. As described above, FIG. 1D illustrates the user interface at the act. As illustrated in FIG. 1D, the process may show each group in which the story reconfiguration for the corresponding contents is being performed. However, when there is no user desired group, the interface for creating the new group may be seen as well. That is, if the user searches the service use group satisfied in the existing use group, the user selects the corresponding group to use the content reconfiguration service within the group. On the other hand, if there is no the satisfactory group, the user creates new groups so as to use the services. In case, in order for the user to rapidly confirm whether the satisfactory service use group is present, the basic information on each group may be provided to the user. In addition, the existing groups are ranked based on each user preference and may be seen to the user.

FIG. 4 is a conceptual diagram for describing a method for generating a new group when there is no congenial user group.

As described above in FIG. 1D, in order to easily collect people having the same tastes at the time of creating the group, the service enables the user to specify the taste to be shared in the group. When the user specifies the taste information and then, requests the generation of the service use group (410), the service creates the group and enables the user to store the group attributes while having the specified information (420). If the user requests the recommendation of the user suitable for the group at the time of generating the group 430, the service extracts the users having the similar tastes based on other users' preference for the group created with the user affinity and then, transmits the invitation messages to the extracted users (440). Thereafter, the preparation work for providing the services to the created group is performed (450).

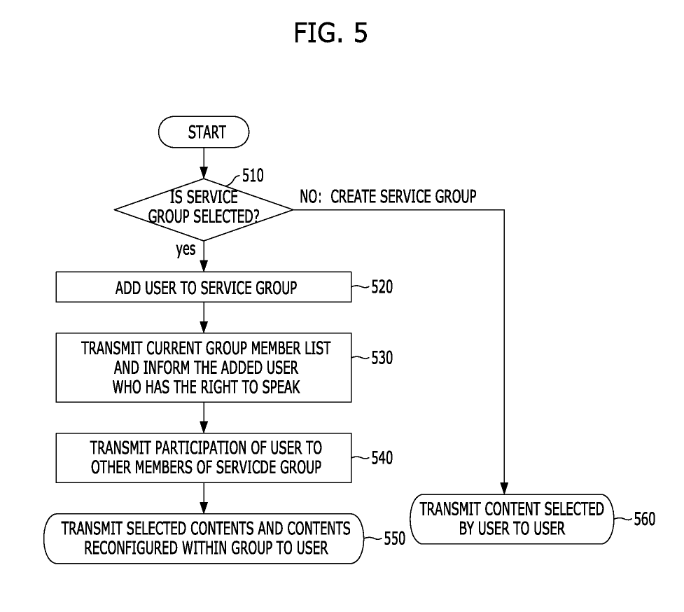

When the user creates or selects the service use group, the data necessary for the interface as illustrated in FIG. 1E for performing the content reconfiguring work are transmitted to the relevant user and the work of updating the service group information, that is, the preparation work for providing the services to the created or selected group is first performed. FIG. 5 illustrates a flow chart of a process of performing the preparation work. When the user creates the user group using the services, there is no group member in the corresponding group and there is no contents reconfigured within the group. Therefore, the contents to be reconfigured are transmitted to the user (560). On the other hand, when the user selects the user group using the service (510), the user is added to the service group (520). Further, the list of other members belonging to the selected user group and the member information having the right to speak are transmitted (530). In addition, the participation of the user is transmitted to other members belonging to the selected user group (540). Then, the content information using the service and the content information reconfigured up to now in the corresponding service group are transmitted to the user (550).

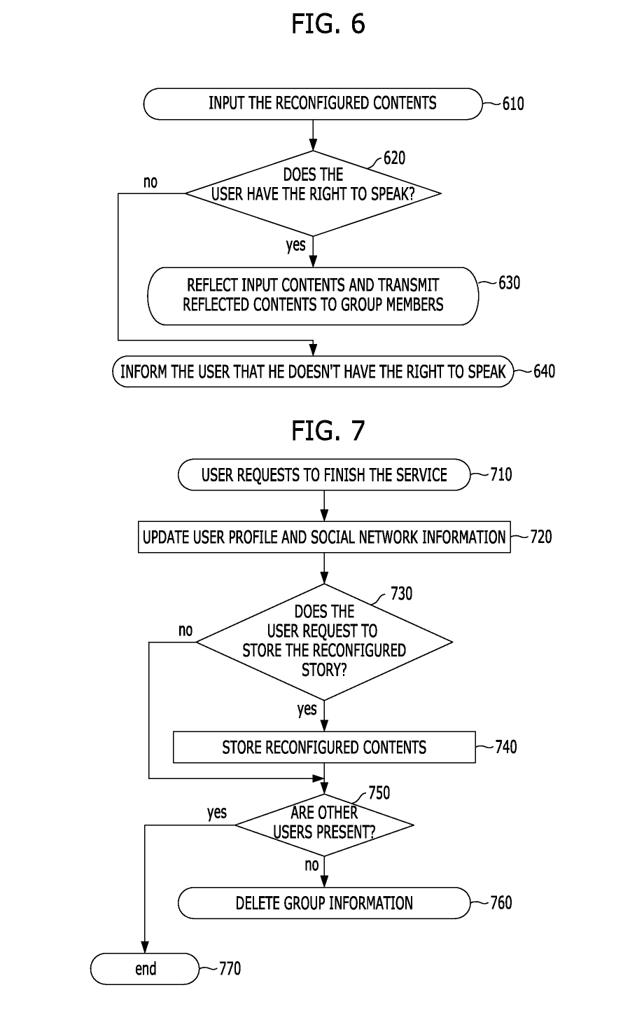

FIG. 6 is a flow chart of an operation performed when a modification work for actual contents is performed within a group in which a user uses the story making services. That is, the process 240 will be described win detail. When the user inputs the reconfigured story based on the basic story so as to reconfigure the contents (610), the service confirms whether the corresponding user has the right to speak (620). In this case, the right to speak is allocated according to the method of allocating the right to speak established at the time of creating the service group. If it is determined that the user does not have the right to speak, no right to speak is informed to the user (640). In this case, the story reconfigured by the user is not reflected. On the other hand, if the user has the right to speak, the service reflects the input contents of the user to the reconfigured contents. Further, the reflected information transmits the information to other users within the group (630).

FIG. 7 is an operating flow chart when the service ends. The user ends the story making services that are being currently used (710), the story making service may manage the corresponding service use history so as to provide smarter services. To this end, the story making service updates the user profile and the social network information based on the service use group and the user's feedback information (720). If the user requests the storage of the story written (reconfigured) up to now for use later (730), the service separately manages the contents written up to now (740). In addition, the service confirms whether another user is present in the corresponding service use group in addition to the user requesting the service ending (750). If it is determined that no user is in the corresponding group, the information on the service use group is deleted (760). On the other hand, when the user is present in the corresponding group, the story making service for the user ends without deleting the group information (770).

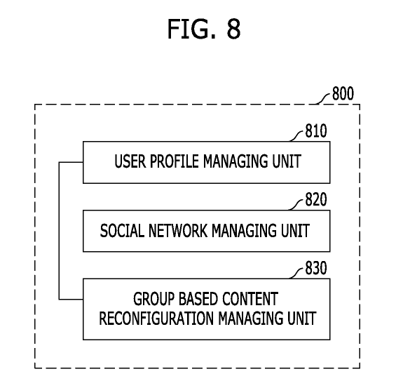

FIG. 8 is a configuration diagram illustrating an apparatus for providing story making services according to the embodiment of the present invention.

In FIG. 8, an apparatus 800 for providing the story making service is configured to include a user profile managing unit 810, a social network managing unit 820, and a group based content reconfiguration managing unit 830. Further, the configuration of FIG. 8 may be present in a single apparatus and may be independently present in each apparatus.

Referring to FIG. 8, an operating process of the apparatus for providing the story making service in accordance with the embodiment of the present invention will be described in detail. The user profile managing unit 810 manages the individual taste information regarding the user. The individual taste information regarding the user includes the information such as the contents, the contents reconfiguration related tastes, or the like, in addition to the basic information such as a name, an age, an occupation, or the like, of a user.

As the available taste information, there may be preferred genres (for example, action, drama, historical drama, SF, or the like), the contents taste information such as interest characters (for example, director, author, main character, or the like), or the like, and the story making taste information such as the preferred ending type (for example, sad/happy), or the like. Further, the user profile managing unit 810 may also include the service use policy taste information of the user group such as the preference information regarding the cooperation rule of the created group.

The social network managing unit 820 enables a user to write/manage the social network information for each individual based on the history information using the story making service. The group based content reconfiguration managing unit 830 recommends the contents and the groups performing the story making to the individuals based on the data managed in the user profile managing unit and the social network managing unit and provides the content reconfiguration services for the group selected by the individuals. Further, the user profile and the social network information are updated based on the group selected by the individuals and the satisfactory information of the group.

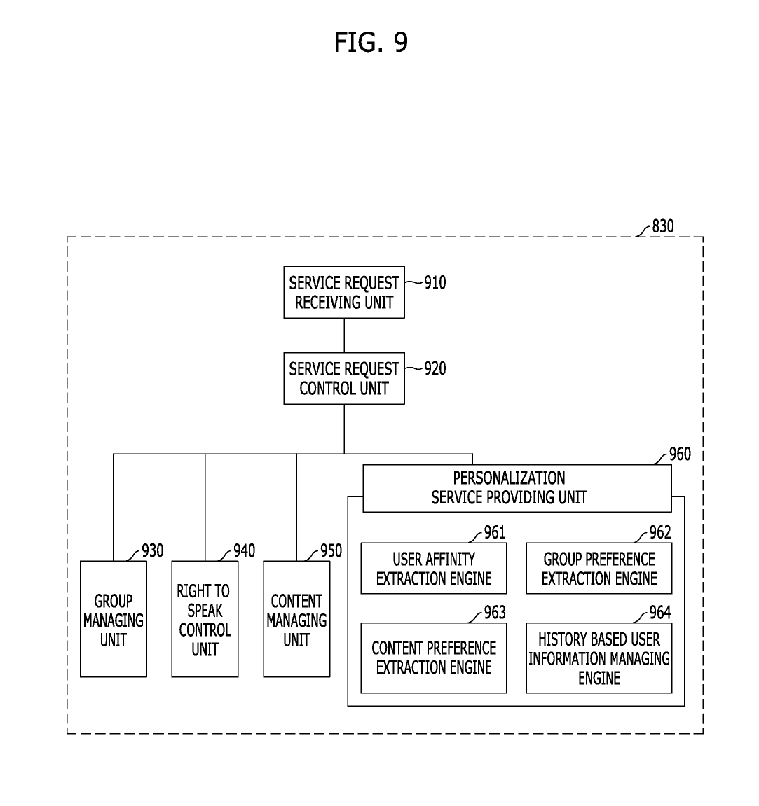

FIG. 9 is a configuration diagram of a group based content reconfiguration managing unit in the apparatus for providing story making services according to the embodiment of the present invention. The group based content reconfiguration managing unit 830 is configured to include a service request receiving unit 910, a service request control unit 920, a group managing unit 930, a right to speak control unit 940, a content managing unit 950, and a personalization service providing unit 960.

Referring to FIG. 9, an operating process of the group based content reconfiguration managing unit 830 among the apparatus 800 for providing the story making service will be described in detail. First, the service request receiving unit 910 receives the story making service request input from the user though the interface of FIGS. 1A and 1E. The service request control unit 920 may control the group managing unit 930, the right to speak control unit 940, the content managing unit 950, the personalization service providing unit 960, respectively, according to the group based content reconfiguration managing unit 830 or may control a combination thereof.

The group managing unit 930 manages the information regarding the groups currently created and using the story making service. Basically, as the information managed by the group managing unit 930, there may be a group ID, content information corresponding to the group, a member belonging to the group, a taste and cooperation rule input at the time of generating the group, service use status information within the group, or the like.

The right to speak control unit 940 serves to control the right to write so as to reconfigure the contents within the group. The content managing unit 950 serves to manage the original story for the contents to be reconfigured, that is, used for the story making service and the individual stories reconfigured by each group and transmit these stories to the user.

The personalization service providing unit 960 serves to provide a customized service based on the user profile information, the social network information and the service use history information. In order to provide the customized service, the personalization service providing unit 960 is configured to include a user affinity extraction engine 961, a group preference extraction engine 962, a content preference extraction engine 963, and a history based user information managing engine 964 and generates and provides the customized information through interaction therebetween.

The user affinity extraction engine 961 calculates the affinity between the user and other users based on the user profile and the social network information. The group preference extraction engine 962 calculates the preference for the group to which the user currently belongs, based on the user profile, the social network information, and the group information for each of the existing service use groups. The content preference extraction engine 963 calculates the content preference for the user based on the user profile. In addition, the user preference for the corresponding contents is calculated using the user preference for the groups using the service for each content based on the results of the group preference extraction engine 962 according to the request.

The history based user information managing engine 964 serves to dynamically manage the user profile and the social network according to the service use pattern of the user. That is, the user profile information and the social network information are updated based on the group characteristics (contents, taste and rule information) selected by the user, the use group after the service use, and the generated feedback information (for example, likes or dislikes) for other users working together. As the simple example of the user profile information update, it may be considered to increase the user preference level for the characteristics commonly shown in the groups frequently selected by the user. Further, the simple example of the social network information update, it may be considered to form and modify the social network for each individual based on people belonging to the group such as the specific user. In this case, the affinity between the individuals may be determined according to how frequently the service is used or what the satisfaction for the service use is.

The group and the contents suitable for the user may be extracted through the personalization service providing unit 960. In addition, other users suitable for the group to which the user belongs may be recommended.

As set forth above, the apparatus and method for providing story marking services in accordance with the exemplary embodiments of the present invention can modify contents by consumers having similar tastes and have various standpoints of individuals watching accidents even though the consumers have similar tastes, such that continuing to story through the cooperation may provide a fun different from enabling a person to modify the story alone. Therefore, the exemplary embodiments of the present invention can provide the participating services to the user in addition to viewing the contents in the contents distribution markets such as IPTV, thereby creating the new consumers. In addition, the method for assisting the medium in which the characteristics of the participation and the interaction such as movies are absent can be used when each medium considers a trend of proposing the alternative plans for reflecting the characteristics because the popularity of contents directing the participation and the interaction has been increased.

While the present invention has been described with respect to the specific embodiments, it will be apparent to those skilled in the art that various changes and modifications may be made without departing from the spirit and scope of the invention as defined in the following claims.

What is claimed is:

1. A method for providing a story making service enabling multiple users to modify/change/rewrite contents, the method for providing a story making service comprising:
recommending and selecting the contents so as to help the users to select the contents performing the story making;
determining a group to create or select the group using the story making together for the selected contents;
generating and transmitting information necessary to provide services within the selected group; and
reconfiguring a story to perform modification/change/rewriting works on the story within the selected contents and the selected service group.

2. The method of claim 1, further comprising:
ending the story making service at the time of request of the user; and
reflecting the service history of the user after the story making service ends.

3. The method of claim 1, wherein the process of selecting the contents includes:
requesting, by the user, services using the story making service; and
recommending contents corresponding to the request; and
selecting, by the user, the recommended contents.

4. The method of claim 3, wherein the requesting of the service enables the user to directly request the story making service to the contents that are currently consumed, to select one of the contents previously purchased by the user and request the selected content, or directly search the desired contents and request the searched contents.

5. The method of claim 3, wherein the recommending of the contents recommends the contents based on individual preference of the contents, preference for the user group, and a popular content ranking and recommends the contents based on each of the individual preference of the contents, the preference for the user group, and the popular content ranking, respectively, or a combination thereof.

6. The method of claim 1, wherein the determining of the group includes:
requesting a service use group generation after the user specifies taste information if it is determined that there is no group of supporting the story making service to be used by the user;
generating the group according to the request and storing group attributes; and
extracting the users having similar tastes based on the user affinity and other users' preference for the created group when the user suitable for the group is recommended and then, transmitting an invitation message to the extracted users.

7. The method of claim 1, wherein the generating and transmitting of the information includes:
adding the user to the service group when the user selects the service group among the current service groups;
transmitting a user list belonging to the current service group and member information currently having a right to speak to the user;
transmitting the participation of the user to other users belonging to the current service group; and
transmitting content information using a service and content information reconfigured up to now in the selected service group to the user.

8. The method of claim 7, further comprising transmitting the contents to be reconfigured to the user when a new service group is created due to the absence of the service group satisfying the story making service to be currently used.

9. The method of claim 1, wherein the reconfiguring of the story includes:
inputting the story reconfigured by the user based on a basic story so as to enable the user to reconfigure the contents;
reflecting the input contents of the user when the user has the right to speak; and
transmitting the reflected contents to other users within the group.

10. The method of claim 9, further comprising informing the user that there is no right to speak, if it is determined that the user does not have the right to speak.

11. The method of claim 2, wherein the ending of the service includes:
requesting, by the user, the ending of the story making service that is currently used;
updating a user profile and social network information based on the service use group and feedback information of the user;
when the user request the storage of the story written up to now for use later, separately storing and managing, by the service, the content written up to now; and
deleting information regarding the service use group when there is no user using the service group.

12. The method of claim 11, further comprising ending the story making service of the user without deleting the group information, if it is determined that there is the user in the corresponding group.

13. An apparatus for providing a story making service enabling multiple users to modify/change/rewrite contents, the apparatus for providing a story making service comprising:
a user profile managing unit configured to manage taste information of the user;
a social network managing unit configured to write and manage social network information for each individual based on history information regarding the story making service used by the user; and
a group based content reconfiguration managing unit configured to recommend a group using the story making service to the individual based on the individual taste information and the social network information for each individual and provide a content reconfiguration service to the group selected by the individual.

14. The apparatus of claim 13, wherein the taste information includes story making taste information such as preferred genres, content taste information such as interest characters, story making taste information such as a preferred ending type, and service use policy taste information of the group to which the user belongs.

15. The apparatus of claim 13, wherein the group based content reconfiguration managing unit includes:
a service request receiving unit configured to receive a service related request from the user;
a group managing unit configured to manage information regarding the groups currently generated and using the story making service;
a right to speak control unit configured to control a right to write for performing content reconfiguration within the group;
a content managing unit configured to manage original contents that are the story making object and reconfigured contents generated according to service using results;
a personalization service providing unit configured to provide a customized service based on the user profile information, the social network information, and the service use history information; and
a service request control unit configured to control the group managing unit, the right to speak control unit, the content managing unit, and the personalization service providing unit, respectively, according to the request of the user or control the combination thereof.

16. The apparatus of claim 15, wherein the information regarding the groups includes a group ID, content information corresponding to the group, a member belonging to the group, a taste and cooperation rule input at the time of creating the group, and service use status information within the group.

17. The apparatus of claim 15, wherein the personalization service providing unit includes:
a user affinity extraction engine configured to calculate affinity between the user and another user based on the user profile and the social network information;
a group preference extraction engine configured to calculate the preference for the user group based on the user profile, the social network information, and the group information regarding the service use group that is current present;
a content preference extraction engine configured to calculate the preference for the contents of the user based on the user profile and the calculated preference of the user group; and
a history based user information managing engine configured to update the user profile and the social network information according to the service use pattern of the user.

18. The apparatus of claim 15, wherein the personalization service providing unit recommends the service use group suitable for the user, recommends the service use contents, and recommends another user suitable for the service use group.
